(19) United States
(12) Patent Application Publication
(10) Pub. No.: US 2018/0032816 A1
(43) Pub. Date: Feb. 1, 2018

(54) FIXATION IDENTIFICATION USING DENSITY OPTIMIZATION

(71) Applicant: WORCESTER POLYTECHNIC INSTITUTE, WORCESTER, MA (US)

(72) Inventors: Andrew C. Trapp, Worcester, MA (US); Soussan Djamasbi, Natick, MA (US); Wen Liu, Worcester, MA (US)

(21) Appl. No.: 15/662,965

(22) Filed: Jul. 28, 2017

Related U.S. Application Data
(60) Provisional application No. 62/368,992, filed on Jul. 29, 2016.

(51) Int. Cl. G06K 9/00; G06K 9/62; G06T 7/73; G06F 3/01

(52) U.S. Cl. CPC G06K 9/00617; G06F 3/013; G06K 9/00604; G06K 9/6218; G06T 7/74

(57) ABSTRACT

A fixation identification system includes an eye-tracking device and a fixation identification device disposed in electrical communication with the eye-tracking device. The fixation identification device includes a controller having a memory and a processor, the controller being configured to identify each gaze position data element received from the eye-tracking device as one of fixation gaze position data and saccade gaze position data, each gaze position data element corresponding to a visual location associated with a field of view at a corresponding time; identify at least one fixation region associated with the fixation gaze position data; adjust a number of fixation gaze position data elements associated with the at least one fixation region; and generate a density optimized fixation region based upon the adjusted number of fixation gaze position data elements.

### RELATED APPLICATIONS

This patent application claims the benefit of U.S. Provisional Application No. 62/368,992, filed on Jul. 29, 2016, entitled, “Fixation Identification Using Density Optimization,” the contents and teachings of which are hereby incorporated by reference in their entirety.

### BACKGROUND

Many complex tasks involve the use of visual displays, such as computer displays. Individuals using these displays are required to make efficient visual searches of their screens to review and/or locate pertinent information. To evaluate an individual's performance as well as a display's usefulness, it is considered desirable to know precisely where and for long an individual looks at the display during critical times. In addition, in assessing the effectiveness of any visual display, it is useful to know not only what features of the display an individual focuses on, but whether cognitive activity occurs.

Eye-tracking provides a metric that can measure what a user read/viewed on the display and can identify cognitive processing associated with the viewing. Conventional eye-tracking devices are configured to record eye-tracking, or gaze, data of a subject that is presented a visual stimulus and to perform fixation identification associated with the eye-tracking data. Fixation identification separates eye-tracking data into fixations and saccades. Fixations identify pauses over regions of interest of the visual display, such as where cognitive processing is believed to occur. Saccades relate to relatively rapid movements of a user's eye between fixations.

Conventional eye-tracking devices can be further configured to utilize different methods to analyze and process eye-tracking data. One method involves the use of gaze-point position (e.g., I-DT filtering). With I-DT filtering, the eye-tracking device is configured to separate eye-tracking data as either fixations or saccades using a predefined maximum dispersion threshold together with a minimum duration value. For example, the eye-tracking device can utilize a fixed-area window to identify fixations by sequentially adding points beyond a minimum duration until the dispersion threshold is exceeded.

Another method to analyze and process the eye-tracking data involves the use of gaze-point velocity (e.g., I-VT filtering). With I-VT filtering, the eye-tracking device is configured to sequentially categorize each gaze point based on its point-to-point velocity. If the velocity associated with a gaze point meets or exceeds a velocity threshold, the eye-tracking device can characterize the gaze point as a saccade. However, if the velocity associated with a gaze point is below the velocity threshold, the eye-tracking device can characterize the gaze point as a fixation.

### SUMMARY

Conventional eye-tracking devices can suffer from a variety of deficiencies. For example, as provided above, conventional eye tracking can be utilized to detect items that a user has viewed, such as on a display screen. The resulting eye-tracking data, or gaze data, can be categorized into two main events or categories: fixations which represent focused eye movement, indicative of awareness and attention, and saccades which represent relatively higher velocity movements that occur between fixation events.

Primary existing methods for identifying fixations use either gaze location (e.g., I-DT filter) or velocity metrics (e.g., I-VT filter). Methods based on gaze location (e.g., I-DT filter) use a constant area size as the threshold for grouping consecutive gaze points into a fixation, while methods based on velocity metrics (e.g., I-VT filter) use a fixed velocity threshold to separate fixations from saccades. While these existing approaches are relatively simple to implement and generally effective, they can lead to issues with precision because they are prone to including points on the fringe of tolerance settings. Because the data generated can lack sensitivity to peripheral points, the use of existing approaches can misrepresent positional and durational properties of fixations and skew summary fixation metrics.

By contrast to conventional methods for comprehension of information from visual information sources, embodiments of the present innovation relate to fixation identification using density optimization. In one arrangement, a fixation identification device is configured to receive gaze position data, such as an (x, y) Cartesian coordinate data element along with associated time information, from an eye tracking device. With this data, the fixation identification device can identify a user's eye position relative to a field of view, such as a display, at a corresponding time. The fixation identification device is configured to identify the gaze position data as either fixation gaze position data or saccade gaze position data and to cluster the fixation gaze position data into successive fixation regions or chunks. The fixation identification device is configured to then identify the densest fixations within a given fixation region using various optimization formulations. In one arrangement, the fixation identification device can utilize a user-selected density adjustment parameter that adjusts the degree of desired density for the fixation regions, thereby allowing decision makers to have fine-tuned control over density during the process.

Based upon the user's eye movement data, and specifically the density of fixation information or optimized fixation density, the adaptive decision support device is configured to detect the user's relative levels of cognitive effort or load. For example, the fixation identification device is configured to utilize the user's density of fixation information to predict the user's activity. In one arrangement, the fixation identification device can utilize the user's density of fixation information to assess the user's visual engagement of an item (e.g., whether a user visually searched for particular information or read a piece of text) and to provide output based upon the assessment.

By detecting the user's cognitive load through changes in the density optimized fixation data, the fixation identification device is configured to provide recommendations for the use of decision models that are best at optimizing the effort-accuracy tradeoff at the detected level of cognitive load. Further, based upon the assessment of the user's visual engagement of an item, the fixation identification device is configured to provide feedback information to an operator regarding the user's visual engagement of an item (e.g., suggestions as to improvements of the design or layout of the item or suggestions to improve the needs of the user). Accordingly, the fixation identification device can serve as a tool in personalizing decision support training.

In one arrangement, a fixation identification device includes a controller having a memory and a processor. The controller is configured to identify each gaze position data element received from an eye-tracking device as one of fixation gaze position data and saccade gaze position data, each gaze position data element corresponding to a visual location associated with a field of view at a corresponding time and identify at least one fixation region associated with the fixation gaze position data. The controller is configured to adjust a number of fixation gaze position data elements associated with the at least one fixation region and generate a density optimized fixation region based upon the adjusted number of fixation gaze position data elements.

In one arrangement, a fixation identification system includes an eye-tracking device and a fixation identification device disposed in electrical communication with the eye-tracking device. The fixation identification device includes a controller having a memory and a processor, the controller being configured to identify each gaze position data element received from the eye-tracking device as one of fixation gaze position data and saccade gaze position data, each gaze position data element corresponding to a visual location associated with a field of view at a corresponding time; identify at least one fixation region associated with the fixation gaze position data; adjust a number of fixation gaze position data elements associated with the at least one fixation region; and generate a density optimized fixation region based upon the adjusted number of fixation gaze position data elements.

In one arrangement, in a fixation identification device, a method for optimizing visual engagement of a field of view, comprising identifying, by the fixation identification device, each gaze position data element received from an eye-tracking device as one of fixation gaze position data and saccade gaze position data, each gaze position data element corresponding to a visual location associated with a field of view at a corresponding time; identifying, by the fixation identification device, at least one fixation region associated with the fixation gaze position data; adjusting, by the fixation identification device, a number of fixation gaze position data elements associated with the at least one fixation region; and generating, by the fixation identification device, a density optimized fixation region based upon the adjusted number of fixation gaze position data elements.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a block diagram of a fixation identification system, according to one arrangement.

FIG. 2 illustrates a flow chart of a procedure performed by the fixation identification device of FIG. 1, according to one arrangement.

FIG. 3 illustrates an image provided by a display of FIG. 1 and gaze position data elements associated with the image, according to one arrangement.

FIG. 4 illustrates the image of FIG. 3, identifying fixation regions associated with the gaze position data, according to one arrangement.

FIG. 5 illustrates a block diagram of a fixation identification system, according to one arrangement.

FIG. 6A illustrates application of a formulation to fixation gaze position data elements, according to one arrangement.

FIG. 6B illustrates application of a formulation to fixation gaze position data elements, according to one arrangement.

FIG. 7 illustrates the image of FIG. 4, identifying density optimized fixation regions associated with an image, according to one arrangement.

FIG. 8A illustrates application of a formulation to fixation gaze position data elements, according to one arrangement.

FIG. 8B illustrates application of a formulation to fixation gaze position data elements, according to one arrangement.

### DETAILED DESCRIPTION

Embodiments of the present innovation relate to fixation identification using density optimization. In one arrangement, a fixation identification device is configured to receive gaze position data, such as an (x, y) Cartesian coordinate data element along with associated time information, from an eye tracking device. With this data, the fixation identification device can identify a user's eye position relative to a field of view, such as a display, at a corresponding time. The fixation identification device is configured to identify the gaze position data as either fixation gaze position data or saccade gaze position data and to cluster the fixation gaze position data into successive fixation regions or chunks. The fixation identification device is configured to then identify the densest fixations within a given fixation region using various optimization formulations. In one arrangement, the fixation identification device can utilize a user-selected density adjustment parameter that adjusts the degree of desired density, thereby allowing decision makers to have fine-tuned control over density during the process.

Based upon the user's eye movement data, and specifically the density of fixation information or optimized fixation density, the adaptive decision support device is configured to detect the user's relative levels of cognitive effort or load. For example, the fixation identification device is configured to utilize the user's density of fixation information to predict the user's activity. In one arrangement, the fixation identification device can utilize the user's density of fixation information to assess the user's visual engagement of an item (e.g., whether a user visually searched for particular information or read a piece of text) and to provide output based upon the assessment.

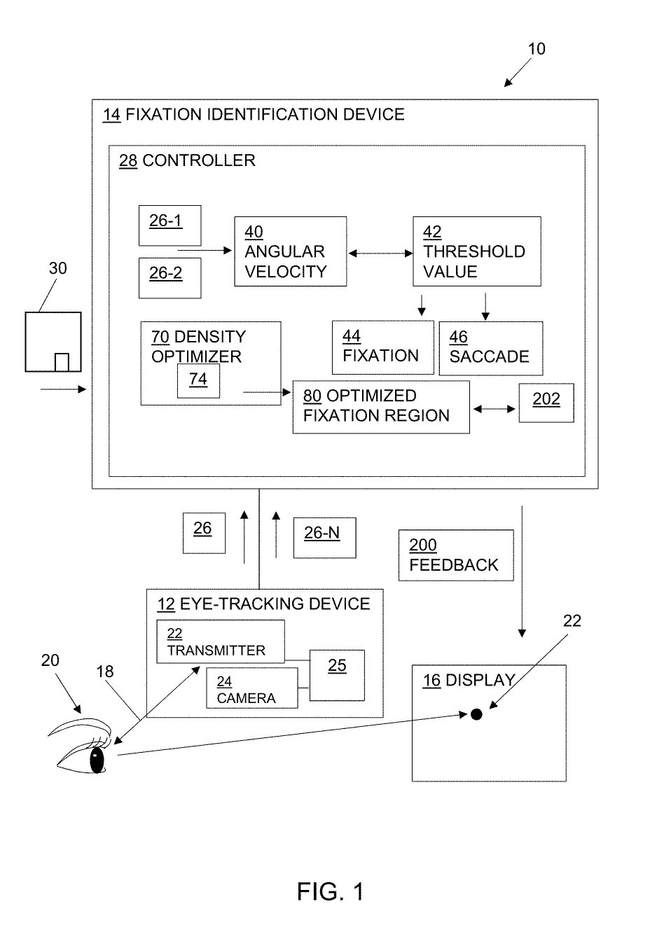

FIG. 1 illustrates a schematic representation of a fixation identification system 10, according to one arrangement. As illustrated, the fixation identification system 10 includes an eye-tracking device 12 disposed in electrical communication with a fixation identification device 14.

The eye-tracking device 12 is configured to detect the position of a user's eye relative to a field of view, such as a display 16 or any image received by the user, whether generated electronically or otherwise, based upon the measured position of the user's eye in space. For example, the eye-tracking device 12 can include an infra-red (IR) transmitter 22 and camera 24 disposed in electrical communication with a controller 25, such as a processor and a memory. The transmitter 22 is configured to direct a light 18, such as an infrared (IR) light, against a user's eye 20. The light 18 allows the camera 24 of the eye-tracking device 12 to identify the pupil of the eye and creates a glint on the surface of the eye 20. The position of the glint relative to the eye-tracking device 12 is substantially stationary. Accordingly, as the user's eye and pupil moves to identify and track various items, such as provided on the display 16, the glint acts as a reference point for the camera 24.

The fixation identification device 14 is configured as a computerized device, such as a personal computer, laptop, or tablet and can include a controller 28, such as a processor and a memory. During operation, as will be described in detail below, the fixation identification device 14 is configured to receive gaze position data elements 26 from the eye-tracking device 12 and to identify user gaze fixation regions utilizing a density optimization approach. For example, the fixation identification device 14 can include a density optimizer 70 configured to optimize a density value associated with a fixation region, such as a region viewed by a user in a field of view. Relatively dense gaze fixation regions identify a more focused visual attention by a user. By utilizing density optimization, rather than solely distance or velocity as is conventionally utilized, the fixation identification device 14 can identify the spatial concentration of gaze points and can correlate the relatively dense concentrations with a user's focus. Based upon the focus, the fixation identification device 14 can provide feedback to the user, such as suggestions regarding optimizing the user's interaction with the field of view.

In one arrangement, each of the eye-tracking device 12 and the fixation identification device 14 are configured as standalone devices disposed in electrical communication with each other. In one arrangement, the fixation identification system 10 includes both the eye-tracking device 12 and the fixation identification device 14 as part of a single device.

The controller 28 of the fixation identification device 14 can store an application for optimizing the density of user gaze fixations. The optimization application installs on the controller 28 from a computer program product 30. In some arrangements, the computer program product 30 is available in a standard off-the-shelf form such as a shrink wrap package (e.g., CD-ROMs, diskettes, tapes, etc.). In other arrangements, the computer program product 30 is available in a different form, such downloadable online media. When performed on the controller 28 of the fixation identification device 14, the optimization application causes the fixation identification device 14 to detect the density of identified fixation regions associated with a user's field of view, such as the view of the display 16. Based upon the detected densities, the optimization application causes the fixation identification device 14 to provide feedback to the user to improve the user's visual interaction with the field of view.

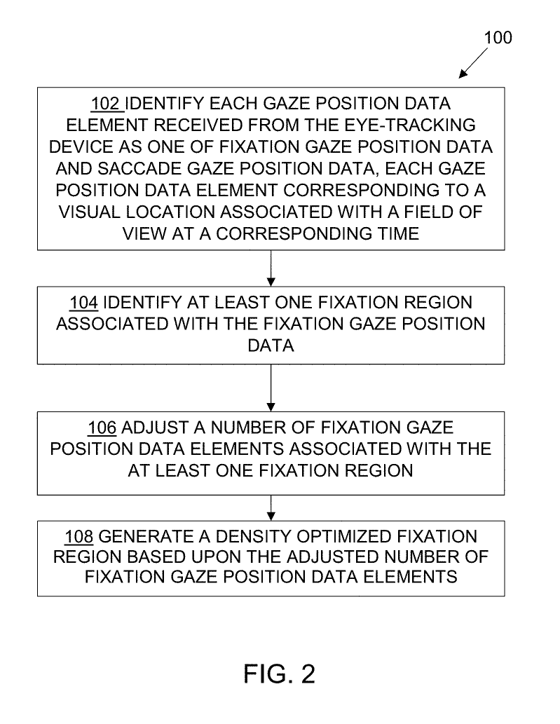

FIG. 2 illustrates a flow chart 100 of a procedure performed by the fixation identification device 14 of the fixation identification system 10 of FIG. 1 when providing fixation identification using density optimization.

In element 102, the fixation identification device 14 is configured to identify each gaze position data element received from the eye-tracking device 12 as one of fixation gaze position data and saccade gaze position data, each gaze position data element corresponding to a visual location associated with a field of view at a corresponding time.

For example, with reference to FIG. 1, as a user visually focuses on a field of view, such as the display 16, the eye-tracking device 12 detects user's eye position in three dimensions (x, y, z) of the user's pupil when viewing a location 22 in a field of view, such as a display 16, and projects the user's eye position into two dimensions (x, y in another coordinate system), so that the two-dimensional coordinate represents where the user is looking in a field of view, such as on the display 16. Based upon the detected positioning of the pupil relative to the glint, the eye-tracking device 12 provides a vertical and lateral coordinate (x, y), termed a gaze position data element 26 herein, to the fixation identification device 14. For example, the gaze position data element 26 corresponds to the user's visual focus on the location 22 on the display 16. Further, for each gaze position data element 26, the controller 24 also collects an associated time measurement (t). For example, the eye-tracking device 24 can be configured to collect gaze position data elements 26 at a rate between about 10 Hz and 1250 Hz. Assuming the case where the eye-tracking device 12 collects data at a rate of 30 Hz, for each gaze position data element collected, the eye-tracking device 12 associates a corresponding time of 1/30 second.

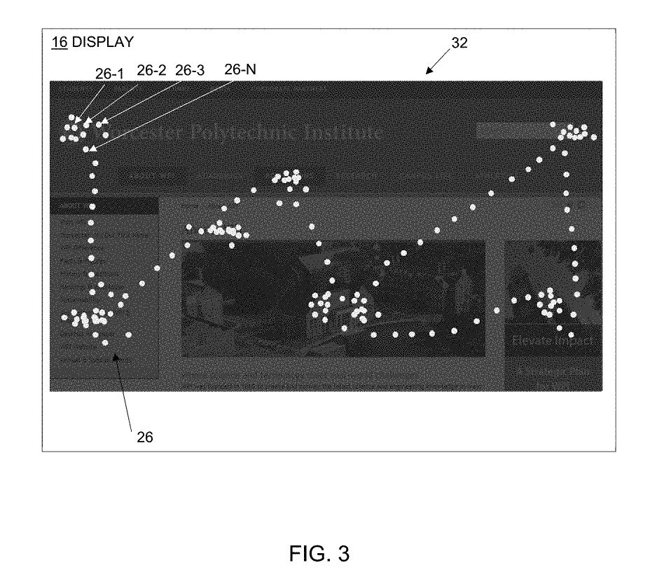

After receiving the gaze position data elements 26, the fixation identification device 14 can identify the user's eye position relative to the field of view. For example, with reference to FIG. 3, based upon the gaze position data elements 26 received from the eye-tracking device 12, the fixation identification device 14 can identify the position of the user's eyes relative to an image 32, such as a website, provided by the display 16.

Returning to FIG. 1, in order to detect the user's relative levels of cognitive effort associated with the viewing of the display 16, the fixation identification device 14 is configured to translate the gaze position data elements 26 into distinct eye-movement, or oculomotorevents. For example, the fixation identification device 14 is configured to separate the gaze position data elements 26 into either fixation gaze position data 44 or saccade gaze position data 46. Fixation gaze position data 44, or fixations, identify pauses over informative regions of interest, where cognitive processing is believed to occur. Fixations characterize attention because they represent effort in maintaining a relatively stable gaze to take foveal snapshots of an object for subsequent processing by the brain. By contrast, saccade gaze position data 46, or saccades, identify relatively rapid movements between fixations, used to recenter the eye on a new location. By identifying certain gaze position data elements 26 as fixation gaze position data, the fixation identification device 14 is configured to detect image regions on which a user has focused his attention and has performed a level of cognitive processing.

The fixation identification device 14 can be configured to separate the gaze position data elements 26 into either fixation gaze position data 44 or saccade gaze position data 46 in a variety of ways. In one arrangement, the fixation identification device 14 distinguish the gaze position data elements 26 based upon the relative angular velocity 40 between consecutive gaze position data elements 26, as provided below.

For example, with additional reference to FIG. 3, assume the case where the fixation identification device 14 receive a first gaze position data element 26-1 which identifies a first visual location (x₁, y₁) of the field of view at an associated first time (t₁). Further, assume the case where the fixation identification device 14 receive a second gaze position data element 26-2, subsequent and consecutive to the first gaze position data element 26-1, which identifies a second visual location (x₂, y₂) of the field of view at an associated second time (t₂).

With the information from the first and second gaze position data elements 26-1, 26-2 and using the position of the glint created by the eye tracking device 12 on the user's eye as the origin, the fixation identification device 14 can detect an angular velocity 40 of the second gaze position data 26-2 relative to the first gaze position data 26-1. With the angular velocity 40 detected, the fixation identification device 14 compares the angular velocity 40 with a velocity threshold value 42 to determine if the second gaze position data 26-2 represents a fixation or a saccade. While the velocity threshold value 42 can have a variety of values, in one arrangement, the velocity threshold value 42 is equal to an angular velocity value of 30°/second.

Based upon the comparison, when the relative angular velocity 40 associated with the second gaze position data 26-2 relative to the first gaze position data 26-1 is below the velocity threshold value 42, the fixation identification device 14 identifies the second visual location associated with the second gaze position data 26-2 as fixation gaze position data 44. Alternately, when the relative angular velocity 40 associated with the second gaze position data 26-2 relative to the first gaze position data 26-1 meets or exceeds the velocity threshold value 42, the fixation identification device 14 identifies the second visual location associated with the second gaze position data 26-2 as saccade gaze position data 46.

Further, the fixation identification device 14 is configured to continue to receive subsequent gaze position data elements 26-N and to analyze these subsequent data elements 26-N to detect the gaze position data elements 26 received from the eye-tracking device 12 as either a fixation gaze position or saccade gaze position in a substantially continuous manner. For example, with additional reference to FIG. 3, for each subsequent gaze position data element 26-N received, the fixation identification device 14 detects the angular velocity 40 of the subsequent gaze position data element 26-N relative to the previous gaze position data element, in this case data element 26-2, and compares the angular velocity 40 with the threshold value 42. Based upon the results of the comparison the fixation identification device 14 can identify the subsequent gaze position data elements 26-N as fixation gaze position data 44 or saccade gaze position data 46. Accordingly, the fixation identification device 14 is configured to provide real time analysis of the gaze position data elements 26 during operation.

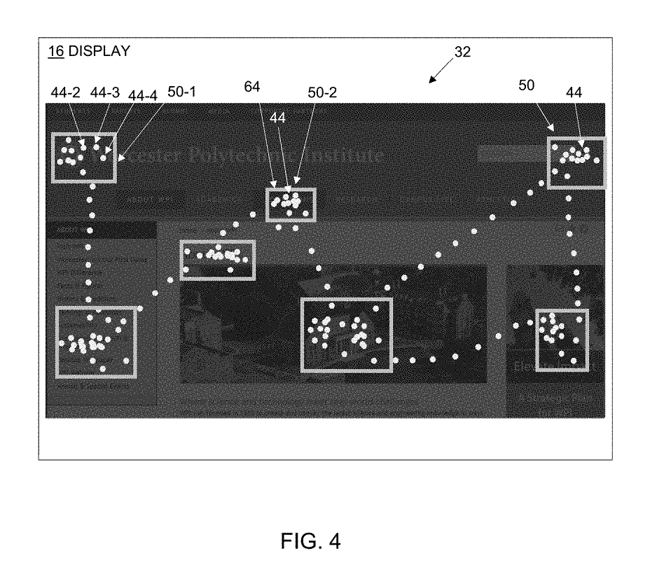

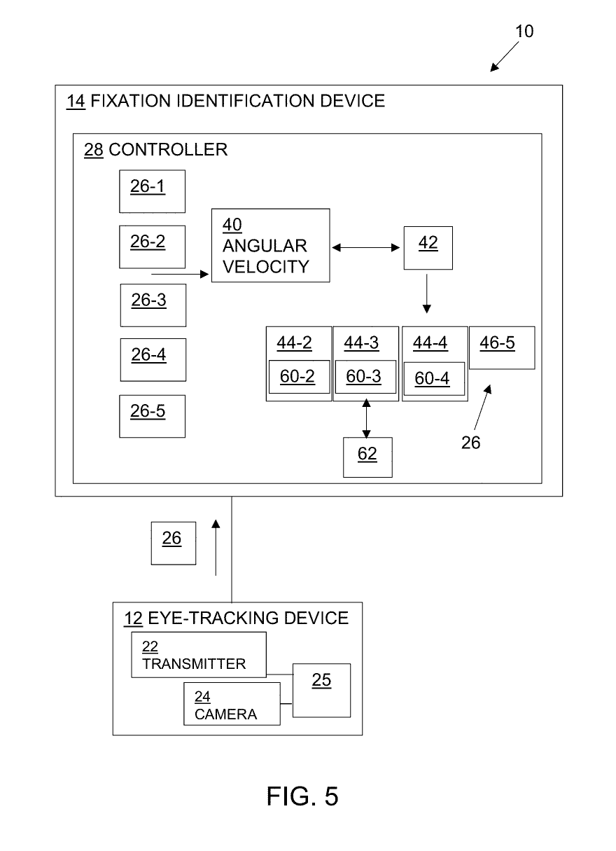

Returning to FIG. 2, as indicated in element 104, as the fixation identification device 14 receives the gaze position data elements 26 and identifies certain data elements 26 as fixation gaze position data elements 44, the fixation identification device 14 is configured to identify at least one fixation region 50 associated with the fixation gaze position data 44. During operation, and with additional reference to FIGS. 4 and 5, as the fixation identification device 14 identifies gaze position data elements 26 as fixation gaze position data elements 44, the fixation identification device 14 groups these fixation gaze position data elements 44 into chunks or fixation regions 50. In one arrangement, the fixation identification device 14 includes certain fixation gaze position data elements 44 as part of a given region 50 based upon the fixation gaze position data elements 44 being consecutive in time and having a particular duration.

For example, during operation and with reference to FIG. 5, the fixation identification device 14 is configured to identify a received number of consecutive gaze position data elements 26 as fixation gaze position data 44. Assume the case where the fixation identification device 14 receives gaze position data elements 26-1 through 26-4. To detect if the gaze position data elements 26-1 through 26-4 are consecutive to each other, the fixation identification device 14 can identify the time measurements (t₁), (t₂), (t₃), and (t₄) of the gaze position data elements 26-1 through 26-4 and can detect if t₄>t₃>t₂>t₁. Following identification of the gaze position data elements 26-1 through 26-4 as being consecutive, the fixation identification device 14 can identify the gaze position data elements 26-2 through 26-4 as being fixation gaze position data elements 44-2 through 44-4 by detecting the relative angular velocity 40 of the elements and comparing to the threshold value 42.

Further, to determine if the data elements 44-2 through 44-4 belong to a single fixation region 50, the fixation identification device 14 is configured to identify a separation event associated with the gaze position data elements 26 received from the eye-tracking device 12. For example, during a gaze sequence, the receipt of a saccade gaze position data element 46 can identify the separation of groupings of fixation gaze position data elements 44. Accordingly, following the receipt of a set of fixation gaze position data elements, in the case where the fixation identification device 14 identifies a received gaze position data element 26 as a saccade gaze position data element 46-5 the fixation identification device 14 can review the consecutive fixation gaze position data elements 44-2 through 44-4 for duration.

In one arrangement, the fixation identification device 14 can compare duration value 60-2 through 60-4 associated with each of the fixation gaze position data elements 44-2 through 44-4 and compare the duration values 60-2 through 60-4 with a duration threshold 62, such as a threshold of at least 100 ms. For example, the duration values 60-2 through 60-4 can identify an amount of time that a user viewed a particular gaze position of a field of view. To determine the duration values 60-2 through 60-4, the fixation identification device 14 is configured to take the difference between a time measurement (t) associated with a given fixation gaze position data element 44 and a time measurement (t) associated with a previous consecutive fixation gaze position data element 44.

In the case when fixation identification device 14 identifies the duration values 60-2 through 60-4 of consecutive fixation gaze position data elements 44-2 through 44-4 as meeting the duration threshold 62, the fixation identification device 14 can identify the fixation gaze position data elements 44-2 through 44-4 as belonging to a given fixation region 50. For example, with reference to FIG. 4, in the case where the consecutive fixation gaze position data elements 44-2 through 44-4 have a duration that is at least 100 ms, the fixation identification device 14 identifies the fixation gaze position data elements 44-2 through 44-4 as being part of the fixation region 50-1.

By grouping particular fixation gaze position data elements 44 with associated fixation regions 50, each fixation region 50 has a particular density, based upon the boundaries of the region 50 and the number of fixation gaze position data elements 44 included in the boundary.

In one arrangement, with reference to FIG. 4, each fixation region 50, such as fixation region 50-2, is defined by a boundary 64 based upon maximum and minimum x-coordinate and y-coordinate values (x, y) associated with the fixation gaze position data 44. For example, the boundary 64 can define a square about the fixation gaze position data 44 such that the maximum y-value of the fixation gaze position data 44 defines the top boundary, the minimum y-value of the fixation gaze position data 44 defines the bottom boundary, the maximum x-value of the fixation gaze position data 44 defines a first side boundary, and the minimum x-value of the fixation gaze position data 44 defines the second side boundary. The density of the fixation region 50-2 is defined as a ratio between the number of fixation gaze position data elements 44 associated with the at least one fixation region 50-2 and an area defined by the boundary 64 of the at least one fixation region 50-2.

It is important to note that the density value associated with the fixation region 50 is distinct from the seemingly similar, but separate, conventional notion of spatial density, which addresses the concept of the proximity of multiple clusters of gaze points (i.e., fixation gaze position data elements). Spatial density involves the post-processing of merging individual fixations into a larger fixation, as performed on a fixation density map, for example. Further, in one arrangement and for multiple fixation regions 50 identified, the fixation identification device 14 is configured to identify the density of a single fixation region 50 at a time.

As provided above, relatively dense gaze fixation regions identify a more focused visual attention by a user. While each fixation region 50 defines a corresponding density, the fixation identification device 14 is further configured to identify the densest fixations within a given fixation region 50. Accordingly, returning to FIG. 2, in element 106, the fixation identification device 14 is configured to adjust a number of fixation gaze position data elements 44 associated with the at least one fixation region 50. Further, in element 108, the fixation identification device 14 is configured to generate a density optimized fixation region 80 based upon the adjusted number of fixation gaze position data elements

When executing elements 106 and 108, with additional reference to FIG. 1, the fixation identification device 14 can utilize the density optimizer 70 to apply an optimization function 74 to the fixation gaze position data elements 44 of each fixation region 50. The optimization function 74 can be configured in a variety of ways. Examples of various optimization function configurations are provided below.

In one arrangement, the optimization function 74 is configured to minimize the number of fixation gaze position data elements 44 associated with a given fixation region 50. For example, utilizing the optimization function 74, the fixation identification device 14 selects a fixation gaze position data element 44 to be included as part of a density optimized fixation region when it improves a density-based metric. Accordingly, the optimization function 74 can be configured to apply the following formulation to the fixation gaze position data elements 44 associated with a given fixation region 50:

$${\sum }_{f = 1}^{F} [ \frac{{\sum }_{i = 1}^{T - 1} {\sum }_{j = i + 1}^{T} {d}_{ij} {z}_{if} {z}_{jf}}{{\sum }_{t = 1}^{T} {z}_{tf}} ] . \qquad ( 1 )$$

Formulation (1) uses values dᵢⱼ as the Euclidean distances between two fixation gaze position data elements 44, i and j, i<j.

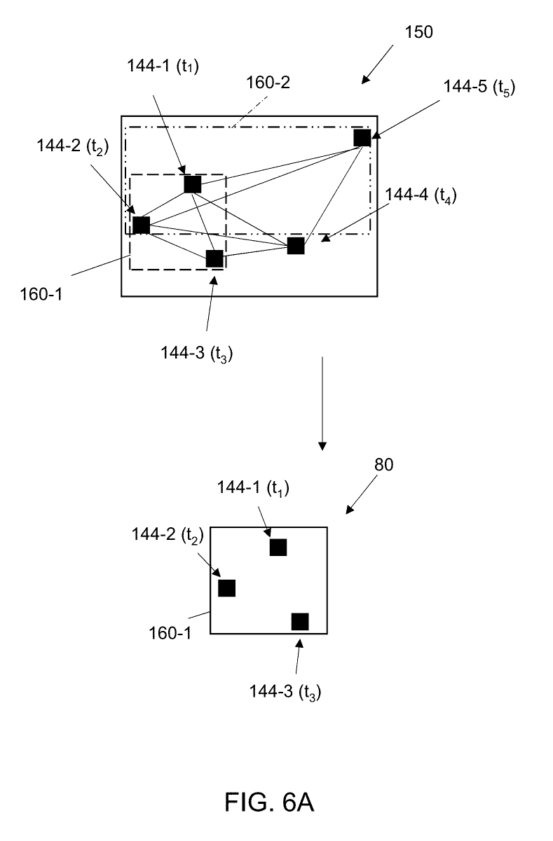

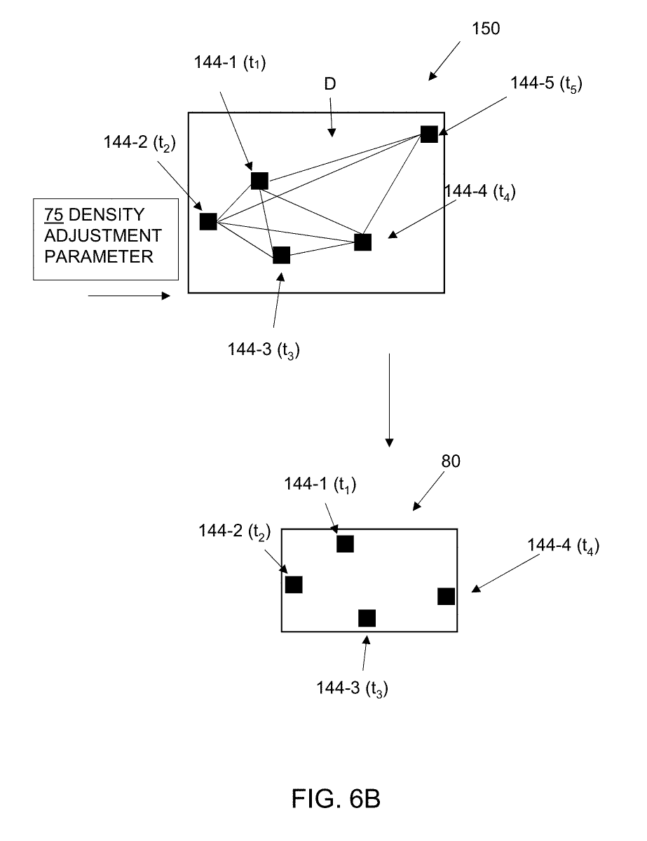

FIG. 6A illustrates the application of the formulation (1) to the fixation gaze position data elements 44 by the fixation identification device 14. For each fixation gaze position data element 144-1 through 144-5 associated with the fixation region 150, the fixation identification device 14 detects a distance D between that a fixation gaze position data element and every other fixation gaze position data element associated with the fixation region 150. For example, with elements 144-1 through 144-5 in the fixation region 150, the fixation identification device 14 computes the distances D using the Euclidean distance between position (x, y) of a first element and position (x, y) of a second element. For the example, as provided in FIG. 6A, the fixation identification device 14 detects the nine distances between each fixation gaze position data element pair.

Next, the fixation identification device 14 is configured to detect various combinations 160 of fixation gaze position data element 144. For example, the fixation identification device 14 can detect elements 144-1 144-2, and 144-3 as part of a first combination of fixation gaze position data elements 160-1 and can detect elements 144-1, 144-2, and 144-5 as part of a second combination of fixation gaze position data elements 160-2.

For each combination 160, the fixation identification device 14 determines if the fixation gaze position data elements 144 within the combination 160 meet a duration threshold 62 (e.g., at least 100 ms) and are consecutive to each other (e.g., t₄>t₃>t₂>t₁). If the fixation gaze position data elements 144 within the combination 160 meet those criteria, the fixation identification device 14 is configured to apply the first term of the formulation (1) to detect a density of the combination of fixation gaze position data elements 160 based upon a ratio of the detected distances (D) of the combination of fixation gaze position data elements and a count of fixation gaze position data elements associated with the combination (z).

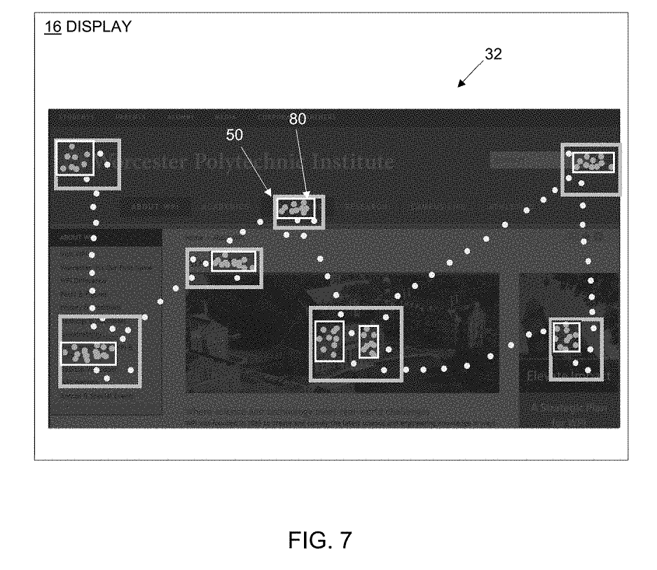

After having detected the density for each qualifying combination of fixation gaze position data elements 160, the fixation identification device 14 is configured to identify the combination 160 having the greatest detected density. Once detected, as indicated in FIGS. 6A and 7, the fixation identification device 14 utilize the fixation gaze position data elements 144 of that densest combination to define the density optimized fixation region 80.

In one arrangement, with reference to FIG. 6B, the fixation identification device 14 is configured to utilize a density adjustment parameter 75 to adjust the degree of desired density for a given fixation region 50. The density adjustment parameter 75 balances a tradeoff between the inclusion of additional fixation gaze position data elements 144 and the spatial concentration of fixation gaze position data elements 144 within a density optimized fixation region 80. The parameter 75 can be configured as a user-selected parameter 75 which allows an end user to discriminate the number of fixation gaze position data elements 144 associated with the fixation region 50 and have fine-tuned control over the density and the resulting density optimized fixation region 80 during operation.

In one arrangement, the formulation (1) can include a second term, as provided below:

$${\sum }_{f = 1}^{F} [ \frac{{\sum }_{i = 1}^{T - 1} {\sum }_{j = i + 1}^{T} {d}_{ij} {z}_{if} {z}_{jf}}{{\sum }_{t = 1}^{T} {z}_{tf}} + α {\sum }_{t = 1}^{T} ( 1 - {z}_{tf} ) ] . \qquad ( 2 )$$

With reference to the formulation (2), the parameter (a) in the second term of the formulation represents the density adjustment parameter 75. The lower the value of the density adjustment parameter 75, the lower the number of additional fixation gaze position data elements 144 included within the density of a combination of fixation gaze position data elements 160. By contrast, the greater the value of the density adjustment parameter 75, the larger the number of additional fixation gaze position data elements 144 included within the density of a combination of fixation gaze position data elements 160. For example, when applying both the first term and the second term of formulation (2), as indicated in FIG. 6B, application of the density adjustment parameter 75 to the fixation gaze position data elements 144 associated with the fixation region 150 results in a greater number of fixation gaze position data elements 144-1 through 144-4 included as part of the density optimized fixation region 80.

In one arrangement, the optimization function 74 is configured to minimize the square area associated with a given fixation region 50. For example, the optimization function 74 can be configured to apply the following formulation to the fixation gaze position data elements 44 associated with a given fixation region 50:

$${\sum }_{f = 1}^{F} [ {r}_{f} ] . \qquad ( 3 )$$

The formulation (3) balances defining a boundary around the largest number of fixation gaze position data elements 44 with a two-dimensional square of minimal area, as measured by half of the side length r.

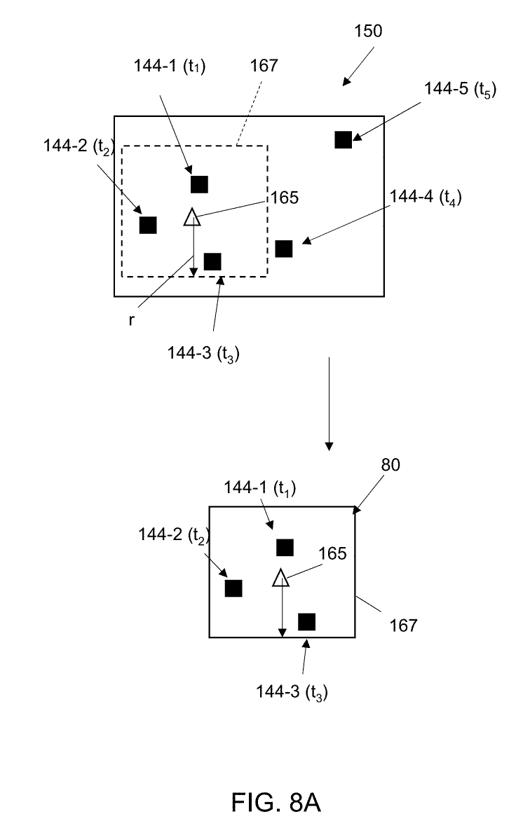

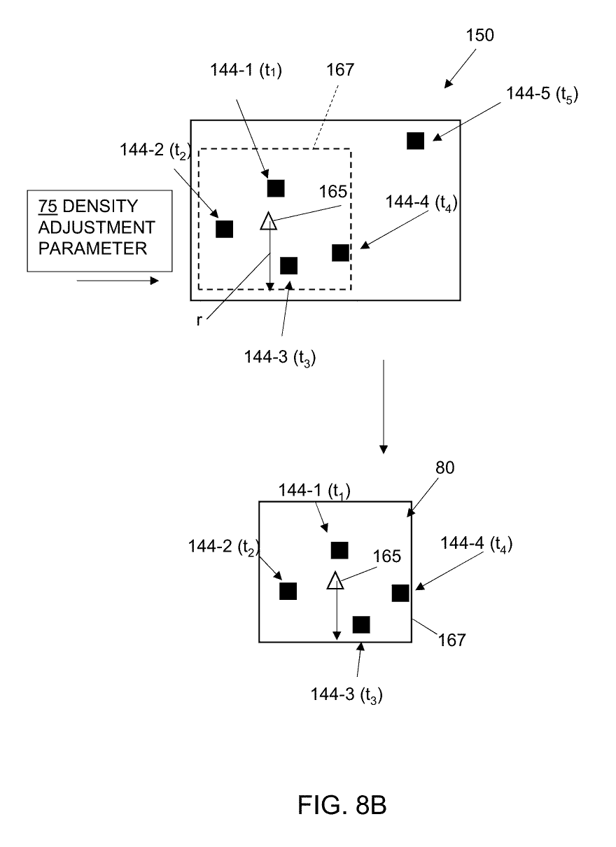

FIG. 8A illustrates the application of the first term of the formulation (3) to the fixation gaze position data elements 44 by the fixation identification device 14. During operation, the fixation identification device 14 selects a fixation center 165 of the fixation region 150 associated with the fixation gaze position data elements 144. The fixation identification device 14 then defines a minimized boundary length r of a fixation center boundary 167 of the fixation region 150 from the selected fixation center 165. When defining, or adding, the minimized boundary length r to the fixation center 165, the fixation identification device 14 sets the corresponding square fixation center boundary 167 with each side having a length 2r.

As the fixation identification device 14 adjusts the position of the fixation center 165 or the boundary length r, the fixation identification device 14 determines if the fixation gaze position data elements 144 within the fixation center boundary 167 meet a duration threshold 62 (e.g., at least 100 ms) and are consecutive to each other (e.g., t₄>t₃>t₂>t₁). If the fixation gaze position data elements 144 within the fixation center boundary 167 meet those criteria, the fixation identification device 14 is configured to identify the fixation center boundary 167 as the density optimized fixation region 80.

In one arrangement, the formulation (3) can include a second term, as provided below:

$${\sum }_{f = 1}^{F} [ {r}_{f} + α {\sum }_{t = 1}^{T} ( 1 - {z}_{tf} ) ] . \qquad ( 4 )$$

With reference to the formulation (4), the parameter (a) in the second term of the formulation represents a density adjustment parameter 75. In one arrangement, the fixation identification device 14 is configured to utilize the density adjustment parameter 75 to adjust the degree of desired density for a given fixation region 50. With reference to the formulation (2), the parameter (a) in the second term of the formulation represents the density adjustment parameter 75. The lower the value of the density adjustment parameter 75, the lower the number of additional fixation gaze position data elements 144 included within the density of a combination of fixation gaze position data elements 160. By contrast, the greater the value of the density adjustment parameter 75, the larger the number of additional fixation gaze position data elements 144 included within the density of a combination of fixation gaze position data elements 160. For example, when applying both the first term and the second term of formulation (4), as indicated in FIG. 8B, application of the density adjustment parameter 75 to the fixation gaze position data elements 144 associated with the fixation region 150 results in a greater number of fixation gaze position data elements 144-1 through 144-4 included as part of the density optimized fixation region 80.

As provided above, the density optimized fixation region 80 provides insight into a user's associated cognitive load and engagement of a field of view, such as a display 16. Based upon the correlation between the density optimized fixation region 80 and a user's cognitive load and engagement, and with reference to FIG. 1, the fixation identification device 14 is configured to provide feedback information 200 to the user, such as via display 16. For example, the feedback information 200 can provide recommendations for the use of decision models that can optimize the effort-accuracy tradeoff at the detected level of cognitive load, as based upon the density optimized fixation region 80.

Further, based upon a correlation of the density optimized fixation region 80 with a user behavior criterion 202, the feedback information 200 can include information regarding the user's visual engagement of an item (e.g., suggestions as to improvements of the design or layout of the image 32, such as a website, provided by the display 16 or suggestions to improve the needs of the user). Accordingly, the fixation identification device 14 can serve as a tool in personalizing decision support training.

The fixation identification device 14 is configured identify density optimized fixation regions 80 based on how densely the fixation gaze position data elements 44 are packed. This is different from the use of IDT (fixed window) and IVT (velocity) in conventional system. By contrast, embodiments of the fixation identification device 14 optimizes the density of an identified fixation region to provide more accurate informative than conventionally detected.

Further, as provided above, the fixation identification device 14 is configured to identify fixation regions 50 associated with the field of view and optimize the density of those regions to accurately detect a user's relative levels of cognitive effort associated with the viewing of a field of view. With the configuration described, the fixation identification device 14 can provide such detection and optimization in substantially real time. Accordingly, the feedback provided to the user can also be provided in substantially real time, such as in order to redirect the user's attention to a particular location in the field of view.

Additionally, by optimizing the density of fixation regions 50, the fixation identification device 14 reduces the computation time needed to identify fixations across a field of view. For example, a user's gaze sequence typically contains a relaively large number of (x, y) coordinats over time. Typical lengths of gaze data sequences are in the tens to hundreds of seconds. For frequencies of 10 Hz to 1250 Hz, the user's gaze sequence can contain between about several hundred to hundreds of thousands of gaze position data elements and may contain thousands of fixation gaze position data elements. For such data instances, fixation region identification can be computationally demanding. By optimizing the density of fixation regions 50, the fixation identification device 14 reduces such computational demand.

Further, the fixation identification device 14 is configured to detect fixation gaze position data based upon optimized density of the fixation regions, as opposed to solely distance (I-DT) or velocity (I-VT), as is performed by conventional devices. By optimizing the density of the fixation regions, the fixation identification device 14 can correlate the resulting density values with two characterizations of cognitive effort: the duration of a fixation, as well as the proximal compactness of the fixations. Fixation duration is a reliable measure of attention and proximal compactness of individual gaze points in a fixation represent a user's focused attention and increased levels of information processing. Accordingly, fixation regions with greater density values tend to exclude peripheral gaze points, thereby improving the accuracy of traditional fixation metrics.

While various embodiments of the innovation have been particularly shown and described, it will be understood by those skilled in the art that various changes in form and details may be made therein without departing from the spirit and scope of the innovation as defined by the appended claims.

What is claimed is:

1. A fixation identification system, comprising:
an eye-tracking device;
a fixation identification device disposed in electrical communication with the eye-tracking device, the fixation identification device comprising a controller having a memory and a processor, the controller configured to:
identify each gaze position data element received from the eye-tracking device as one of fixation gaze position data and saccade gaze position data, each gaze position data element corresponding to a visual location associated with a field of view at a corresponding time,
identify at least one fixation region associated with the fixation gaze position data,
adjust a number of fixation gaze position data elements associated with the at least one fixation region, and
generate a density optimized fixation region based upon the adjusted number of fixation gaze position data elements.

2. The fixation identification system of claim 1, wherein, when identifying gaze position data received from the eye-tracking device as one of fixation gaze position data and saccade gaze position data, the controller is configured to:
receive first gaze position data identifying a first visual location of the field of view at an associated first time;
receive second gaze position data identifying a second visual location of the field of view at an associated second time, the second gaze position data received subsequent and consecutive to the first gaze position data; and
detect an angular velocity of the second gaze position data relative to the first gaze position data;
when a relative angular velocity associated with the second gaze position data relative to the first gaze position data is below a velocity threshold value, identify the second visual location associated with the second gaze position data as fixation gaze position data, and
when the relative angular velocity associated with the second gaze position data relative to the first gaze position data one of meets or exceeds the velocity threshold value, identify the second visual location associated with the second gaze position data as saccade gaze position data.

3. The fixation identification system of claim 2, wherein the controller is configured to:
detect an angular velocity of each subsequent gaze position data received relative to each previous gaze position data received;
when a relative angular velocity associated with the subsequent gaze position data relative to the previous gaze position data is below the velocity threshold value, identify the subsequent visual location associated with the subsequent gaze position data as fixation gaze position data; and
when the relative angular velocity associated with the subsequent gaze position data relative to the previous gaze position data one of meets or exceeds the velocity threshold value, identify the subsequent visual location associated with the subsequent gaze position data as saccade gaze position data.

4. The fixation identification system of claim 1, wherein when identifying the at least one fixation region associated with the fixation gaze position data, the controller is configured to:
identify a received number of consecutive gaze position data elements as fixation gaze position data; and
in response to identifying a gaze position data element as saccade gaze position data, compare the received number of consecutive gaze position data elements identified as fixation gaze position data with a duration threshold,
when the received number of consecutive gaze position data elements identified as fixation gaze position data meets the duration threshold, identify the fixation gaze position data as a fixation region.

5. The fixation identification system of claim 1, wherein when adjusting the number of fixation gaze position data elements associated with the at least one fixation region, the controller is configured to:
for each fixation gaze position data element associated with the at least one fixation region, detect a distance between that fixation gaze position data element and every other fixation gaze position data element associated with the at least one fixation region,
for each combination of fixation gaze position data elements associated with the at least one fixation region, when the combination of fixation gaze position data elements both together meet a duration threshold and are consecutive to each other, detect a density of the combination of fixation gaze position data elements based upon a ratio of the detected distances of the combination of fixation gaze position data elements and a count of fixation gaze position data elements associated with the combination; and
when generating the density optimized fixation region based upon the adjusted number of fixation gaze position data elements, the controller is configured to utilize the fixation gaze position data elements of the combination of fixation gaze position data elements having the greatest detected density.

6. The fixation identification system of claim 1, wherein when adjusting the number of fixation gaze position data elements associated with the at least one fixation region, the controller is configured to:
select a fixation center associated with the at least one fixation region associated with the fixation gaze position data;
define a minimized boundary length of a fixation center boundary of the at least one fixation region from the selected fixation center;
when the defined fixation center boundary contains a combination of fixation gaze position data elements that both meets a duration threshold and are consecutive to each other, identify the fixation center boundary as the density optimized fixation region.

7. The fixation identification system of claim 1, wherein when adjusting the number of fixation gaze position data elements associated with the at least one fixation region, the controller is configured to apply a user-selected density adjustment parameter to discriminate the number of fixation gaze position data elements associated with the at least one fixation region.

8. The fixation identification system of claim 1, wherein the controller is further configured to provide feedback information based upon the density optimized fixation region.

9. The fixation identification system of claim 8, wherein when providing feedback information based upon the density optimized fixation region, the controller is configured to:
correlate the density optimized fixation region with a user behavior criterion; and
provide the feedback information based upon the user behavior criterion.

10. In a fixation identification device, a method for optimizing visual engagement of a field of view, comprising:
identifying, by the fixation identification device, each gaze position data element received from an eye-tracking device as one of fixation gaze position data and saccade gaze position data, each gaze position data element corresponding to a visual location associated with a field of view at a corresponding time;
identifying, by the fixation identification device, at least one fixation region associated with the fixation gaze position data;
adjusting, by the fixation identification device, a number of fixation gaze position data elements associated with the at least one fixation region; and
generating, by the fixation identification device, a density optimized fixation region based upon the adjusted number of fixation gaze position data elements.

11. The method of claim 10, wherein, identifying gaze position data received from the eye-tracking device as one of fixation gaze position data and saccade gaze position data comprises:
receiving, by the fixation identification device, first gaze position data identifying a first visual location of the field of view at an associated first time;
receiving, by the fixation identification device, second gaze position data identifying a second visual location of the field of view at an associated second time, the second gaze position data received subsequent and consecutive to the first gaze position data; and
detecting, by the fixation identification device, an angular velocity of the second gaze position data relative to the first gaze position data;
when a relative angular velocity associated with the second gaze position data relative to the first gaze position data is below a velocity threshold value, identifying, by the fixation identification device, the second visual location associated with the second gaze position data as fixation gaze position data, and
when the relative angular velocity associated with the second gaze position data relative to the first gaze position data one of meets or exceeds the velocity threshold value, identifying, by the fixation identification device, the second visual location associated with the second gaze position data as saccade gaze position data.

12. The method of claim 11, comprising:
detecting, by the fixation identification device, an angular velocity of each subsequent gaze position data received relative to each previous gaze position data received;
when a relative angular velocity associated with the subsequent gaze position data relative to the previous gaze position data is below the velocity threshold value, identifying, by the fixation identification device, the subsequent visual location associated with the subsequent gaze position data as fixation gaze position data; and
when the relative angular velocity associated with the subsequent gaze position data relative to the previous gaze position data one of meets or exceeds the velocity threshold value, identifying, by the fixation identification device, the subsequent visual location associated with the subsequent gaze position data as saccade gaze position data.

13. The method of claim 10, wherein identifying the at least one fixation region associated with the fixation gaze position data comprises:
identifying, by the fixation identification device, a received number of consecutive gaze position data elements as fixation gaze position data; and
in response to identifying a gaze position data element as saccade gaze position data, comparing, by the fixation identification device, the received number of consecutive gaze position data elements identified as fixation gaze position data with a duration threshold,
when the received number of consecutive gaze position data elements identified as fixation gaze position data meets the duration threshold, identifying, by the fixation identification device, the fixation gaze position data as a fixation region.

14. The method of claim 10, wherein adjusting the number of fixation gaze position data elements associated with the at least one fixation region comprises:
for each fixation gaze position data element associated with the at least one fixation region, detecting, by the fixation identification device, a distance between that fixation gaze position data element and every other fixation gaze position data element associated with the at least one fixation region,
for each combination of fixation gaze position data elements associated with the at least one fixation region, when the combination of fixation gaze position data elements both together meet a duration threshold and are consecutive to each other, detecting, by the fixation identification device, a density of the combination of fixation gaze position data elements based upon a ratio of the detected distances of the combination of fixation gaze position data elements and a count of fixation gaze position data elements associated with the combination; and
when generating the density optimized fixation region based upon the adjusted number of fixation gaze position data elements utilizing, by the fixation identification device, the fixation gaze position data elements of the combination of fixation gaze position data elements having the greatest detected density.

15. The method of claim 10, wherein adjusting the number of fixation gaze position data elements associated with the at least one fixation region comprises:
selecting, by the fixation identification device, a fixation center associated with the at least one fixation region associated with the fixation gaze position data;
defining, by the fixation identification device, a minimized boundary length of a fixation center boundary of the at least one fixation region from the selected fixation center;
when the defined fixation center contains a combination of fixation gaze position data elements that both meets a duration threshold and are consecutive to each other, identifying, by the fixation identification device, the fixation center boundary as the density optimized fixation region.

16. The method of claim 10, wherein adjusting the number of fixation gaze position data elements associated with the at least one fixation region comprises applying, by the fixation identification device, a user-selected density adjustment parameter to discriminate the number of fixation gaze position data elements associated with the at least one fixation region.

17. The method of claim 10, further comprising providing, by the fixation identification device, feedback information based upon the density optimized fixation region.

18. The method of claim 17, wherein providing feedback information based upon the density of fixation information associated with the at least one fixation region comprises:
correlating, by the fixation identification device, the density optimized fixation region with a user behavior criterion; and
providing, by the fixation identification device, the feedback information based upon the user behavior criterion.

19. A fixation identification device, comprising:
a controller having a memory and a processor, the controller configured to:
identify each gaze position data element received from an eye-tracking device as one of fixation gaze position data and saccade gaze position data, each gaze position data element corresponding to a visual location associated with a field of view at a corresponding time;
identify at least one fixation region associated with the fixation gaze position data;
adjust a number of fixation gaze position data elements associated with the at least one fixation region; and
generate a density optimized fixation region based upon the adjusted number of fixation gaze position data elements.
